(19) United States
(12) Patent Application Publication
(10) Pub. No.: US 2007/0011617 A1
(43) Pub. Date: Jan. 11, 2007

(54) Three-dimensional graphical user interface

(76) Inventors: Mitsunori Akagawa, Kawasaki-shi (JP); Michael M. Tso, Saratoga, CA (US); Shoji Ishida, Kashiwa-shi (JP); Keizo Fukahori, Ohta-ku (JP)

Correspondence Address: CROWELL & MORING LLP;INTELLECTUAL PROPERTY GROUP, P.O. BOX 14300, WASHINGTON, DC, 20044-4300, US

(21) Appl. No.: 11/292,841

(22) Filed: Dec. 1, 2005

Related U.S. Application Data
(60) Provisional application No. 60/697,335, filed on Jul. 6, 2005.

(51) Int. Cl. G06F 9/00

(52) U.S. Cl. 715/738; 715/850; 715/849; 715/848

(57) ABSTRACT

A three-dimensional graphical user interface includes a graphical display, and a memory storing a geometric space including a plurality of three-dimensional cells. Each cell is linked to at least one other cell through an adjoining surface. A program memory includes instructions for causing the graphical user interface to display an interior view of one of the cells, the view controllable by the user through a walkthrough interface, and display an exterior view of the geometric space, the view controllable by the user through rotation and zoom functions.

### CROSS REFERENCE TO RELATED APPLICATION

The present invention claims priority to U.S. Provisional Patent Application No. 60/697,335, filed on Jul. 6, 2005, the disclosure of which is incorporated herein by reference.

### FIELD OF THE INVENTION

The present invention relates generally to graphical user interfaces and more particularly to three-dimensional graphical user interface systems and methods for mobile devices.

### BACKGROUND OF THE INVENTION

Many wireless carriers generate revenue by delivering content services such as online gaming, Internet web browsing, online shopping and social networking services to their mobile subscribers. The content services offered by wireless carriers, however, are limited by the capabilities of today's cost-effective mobile devices.

One constraint on wireless content delivery is the personal computer-based user interfaces utilized by mobile devices. Operating systems on personal computers and mobile devices commonly include a hierarchical interface facilitating access to resources allocated in a layered directory. Content delivery is typically facilitated by a web browser interface designed to display a two-dimensional web page that may contain text, pictures, movies and other content. Each web page is accessed through a uniform resource locator (URL) address and may include hyperlinks to other web pages or content to enable navigation from one page or section to another.

Most web pages are designed for display on personal computers with large display screens. Navigating these web pages is often inconvenient and difficult when presented on the small display of a mobile device, such as a mobile telephone or personal digital assistant. Only a portion of a web page designed for a personal computer can be viewed on a small device at one time, resulting in a long strip page on the small device and time consuming scrolling to view the entire web page. Further, the logical relationship between objects on a web page visually aids the personal computer user in navigating web pages. Many of these logical relationships are lost when only a portion of the information is displayed at one time, making the browsing experience more difficult and less intuitive for the mobile user.

Conventional mobile user interfaces are not effective for the majority of casual users who access the Internet and online services as a convenience. These mobile interfaces further constrain the types of content delivery services that are available to the mobile user. Accordingly, there is a need for a mobile user interface that allows a mobile user to more intuitively and conveniently view and locate content.

### SUMMARY OF THE INVENTION

The present invention provides a three-dimensional graphical user interface for use with mobile devices, personal computers and other systems and devices. In one embodiment, a three-dimensional graphical user interface includes a graphical display and a memory storing a geometric space including a plurality of three-dimensional cells. Each cell is linked to at least one other cell through an adjoining surface. A program memory includes instructions for causing the graphical user interface to display an interior view of one of the cells, the view controllable by the user through a walkthrough interface, and display an exterior view of the geometric space, the view controllable by the user through rotation and zoom functions.

In an embodiment of the present invention, each three-dimensional cell includes an interior and an exterior, each capable of being viewed on the graphical display. The interior of a first cell includes a transport reactor object associated with a second cell and adapted for user interaction. When a user interacts with the transport reactor object, the transport reactor object changes the display view to the interior of the second cell.

Each cell is a hexagonal prism and at least one cell includes a content texture mapped on an interior surface. In an alternative embodiment, the cell is an n-sided prism, where n is greater 4. The three-dimensional geometric space corresponds to a physical space, with at least one cell including content associated with a corresponding portion of the physical space.

In another embodiment, a method for viewing content on a mobile device includes transmitting a request for three-dimensional content to a content server, receiving cell data associated with the requested content and building a virtual three-dimensional cell using the received call data. A view of the cell's interior is displayed and an interactive walkthrough interface changes the displayed view of the cell's interior in response to user input.

The cell's interior may include at least one reactor object that responds based on a distance between the user's position in the cell's interior and the position of the reactor object. In one embodiment, the three-dimensional content includes a two-dimensional web page, and the step of building includes texture mapping the web page on an interior surface of the cell. A hypertext link from the web page may be facilitated using a reactor object. In a second embodiment, the request includes user information and location information, and the cell data includes content relating to the user and location information.

In another embodiment of the present invention, a content delivery system includes a content database and a content server. The content database stores data representing a virtual three-dimensional geometric space including a plurality of linked three-dimensional cells. The content server is coupled to the content database and includes a program memory storing program instructions for causing the content server to receive a request for three-dimensional content from the mobile device, retrieve data associated with the requested content, construct a cell with the retrieved content, and transmit the constructed cell to the mobile device. In one embodiment, the transmitted cell includes dynamic content, and the content server periodically pushes new dynamic content to the mobile device for display in the transmitted cell. A user database may also be provided storing user profile data, which is used to select cell content for the user. The content delivery system may further track the mobile device's movement through the virtual three-dimensional geometric space.

### BRIEF DESCRIPTION OF THE DRAWINGS

FIG. 1 illustrates a mobile network in accordance with an embodiment of the present invention;

FIGS. 2a-b illustrate a client device in accordance with an embodiment of the present invention;

FIGS. 3a-c illustrate a hexagonal cell in accordance with an embodiment of the present invention;

FIG. 4 illustrates a cluster of cells in accordance with an embodiment of the present invention;

FIGS. 5a and 5b illustrate linking and bonding of clusters in accordance with embodiments of the present invention;

FIG. 6 illustrates space structure data in accordance with an embodiment of the present invention;

FIG. 7 illustrates an interaction between an actor and reactor in accordance with an embodiment of the present invention;

FIG. 8 illustrates interactions between an actor and transport reactors in accordance with an embodiment of the present invention;

FIG. 9 illustrates an embodiment of a community services system;

FIG. 10 illustrates an embodiment of an interface between a client device, carrier network and community server;

FIG. 11 illustrates the delivery of content from a real community server to a client device in accordance with an embodiment of the present invention;

FIG. 12 illustrates a real community service in accordance with an embodiment of the present invention;

FIG. 13 illustrates an embodiment of an interaction between a community server and a mobile device;

FIG. 14 illustrates a web browser application in accordance with an embodiment of the present invention;

FIG. 15 illustrates an online shopping application in accordance with an embodiment of the present invention; and

FIG. 16 illustrates an embodiment of an interactive walkthrough interface in a chat environment.

### DETAILED DESCRIPTION

The present invention provides a three-dimensional graphical user interface for use with mobile devices, personal computers and other systems and devices.

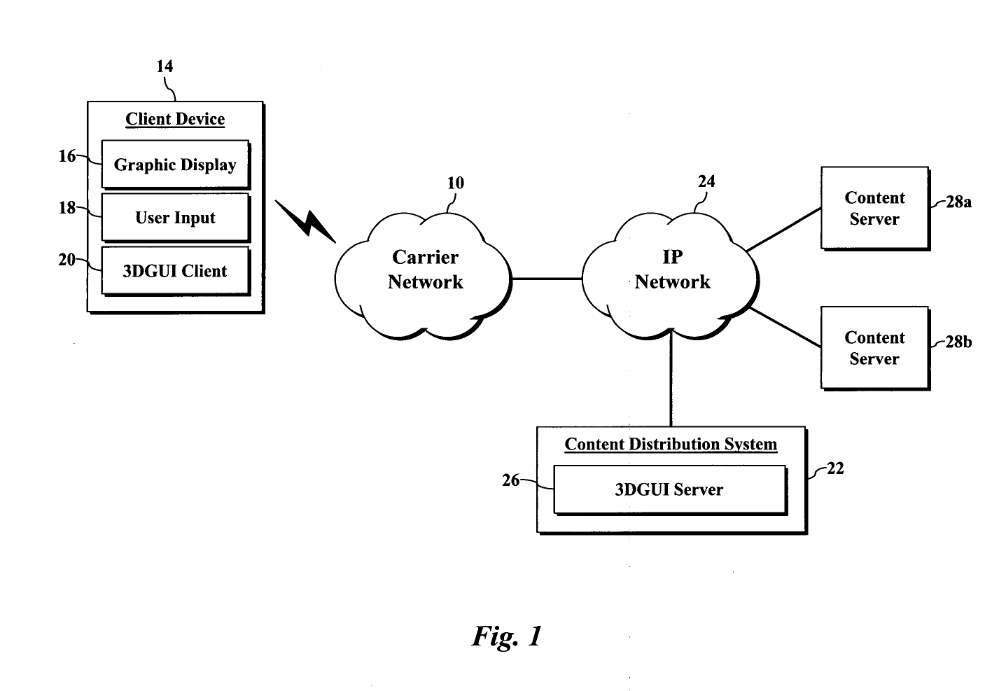

In one embodiment, a three-dimensional graphical user interface (3DGUI) facilitates content delivery in a mobile network. As illustrated in FIG. 1, a carrier network 10 provides wireless communications services to at least one client device 14. The carrier network 10 supports at least one wireless communications protocol such as Global System for Mobile communications (GSM), General Packet Radio Service (GPRS), Code Division Multiple Access (CDMA) or Wideband CDMA (WCDMA). The client device 14 may be any device that is adapted to communicate with the carrier network 10 such as a mobile phone, personal digital assistant (PDA) or handheld computer.

The client device 14 includes a graphic display 16, a user input device 18 and a 3DGUI client 20. In operation, the 3DGUI client 20 facilitates a three-dimensional graphical user interface on the graphic display 16. Using the input device 18, the user may interact with the displayed 3D image by walking through the 3D environment. The 3DGUI may be used as an operating system interface, an application interface, a web browser interface or an interface to other environments in which there is user interaction. The 3DGUI client 18 is also adapted to request content from a content distribution system 22, which is connected to the carrier network 10 through an IP network 24, such as the Internet. The content distribution system 22 includes a 3DGUI server 26 that provides content delivery services to the client device 14, including retrieving content from at least one content server 28a-b connected to the IP network 24.

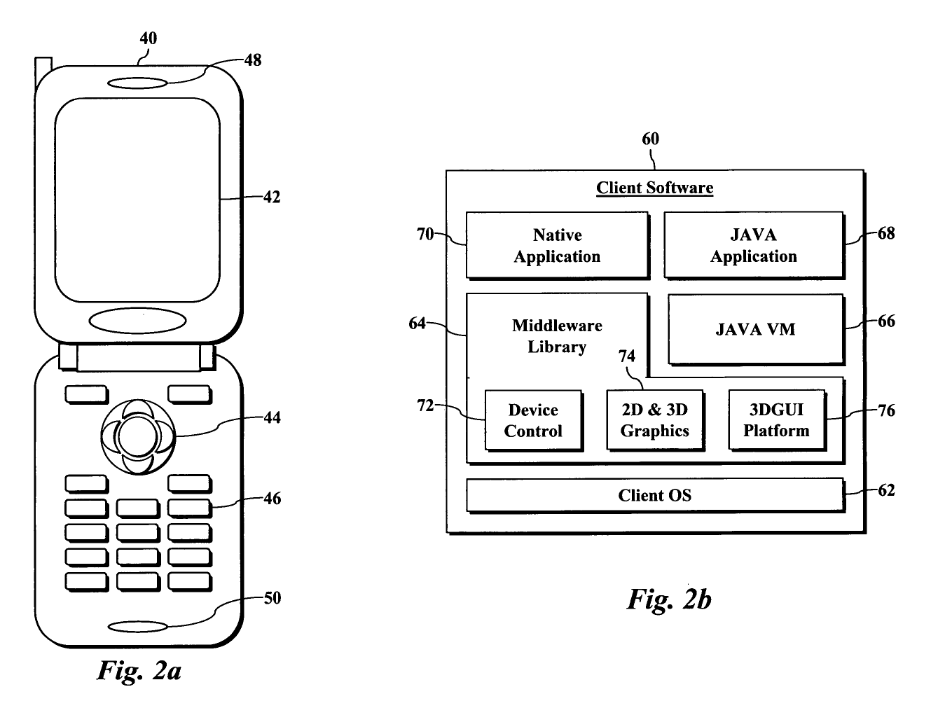

An embodiment of a client device is further illustrated in FIGS. 2a-b. A mobile phone 40 includes a display 42, a directional input device 44, a keypad 46, a speaker 48 and a microphone 50. The mobile phone 40 includes client software 60, including a mobile phone operating system 62, a middleware library 64, a java virtual machine 66 and at least one application, which may include a Java Application 68 and a Native Application 70. It will be appreciated that the client software 60 may be implemented as software, hardware or a combination thereof, and may incorporate alternative programming and operating environments.

The middleware library 64 includes device control functions 72, 2D and 3D graphics APIs 74, and functions to facilitate a 3DGUI platform 76. The device control functions 72 include key sense operations, display control (e.g., backlight LCD blinking), vibration control, music and sound control and other device-specific control functions. The graphics APIs 74 include 2D and 3D graphics functions including basic primitive handling, rendering, texturing and materials functions, translation, rotation and scaling of 3D objects and animation. In the exemplary embodiment the graphics APIs 74 include functions for lighting effects including Gouraud shading, environmental lighting, environmental mapping (specular light) and tune shading. Standard graphics APIs may be used such as APIs defined in the OpenGL standard. The 3DGUI platform includes APIs for implementing the 3DGUI described herein, including functions for building and managing cells, reactors and actors, displaying cells and walkthrough interactivity.

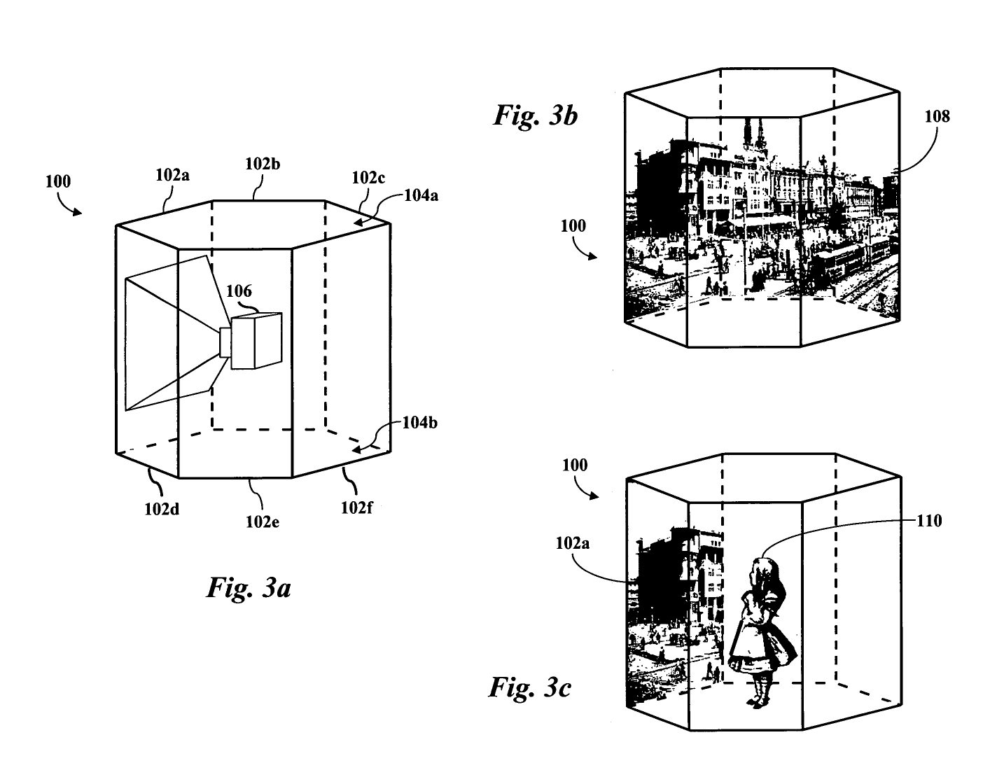

An embodiment of the 3DGUI will now be described with reference to FIGS. 3-8. The 3DGUI of this embodiment facilitates an improved use of mobile display space over conventional two-dimensional user interfaces, allowing more content to be expressed on mobile displays and providing an intuitive interface. The 3DGUI provides a three-dimensional interface while efficiently using mobile resources and communications bandwidth. The 3DGUI provides a platform for a variety of content services including web browsing, online gaming and social network services.

Referring to FIGS. 3a-c, the 3DGUI provides the user with a view of a three-dimensional graphic space, which includes at least one cell 100. The cell 100 includes a plurality of internal surfaces, including rectangular walls 102a-f and a hexagonal ceiling 104a and a hexagonal floor 104b. Each internal surface has a visual texture 108, which may be viewed from inside the cell 100 from the point of view of a camera 106 or a character 110. In the present embodiment, the cell 100 is a hexagonal prism, but it should be appreciated that in alternate embodiments other shapes may be used for the cell. From inside the cell 100, a user may navigate the three-dimensional geographic space defined by cell 100 by browsing viscerally as the character 110 (or camera 106) is walking and interacting inside the geometrical space. Constructing the cell 100 for 3D display includes geometry processing of the cell surfaces and view, rasterization and texture mapping of the surfaces.

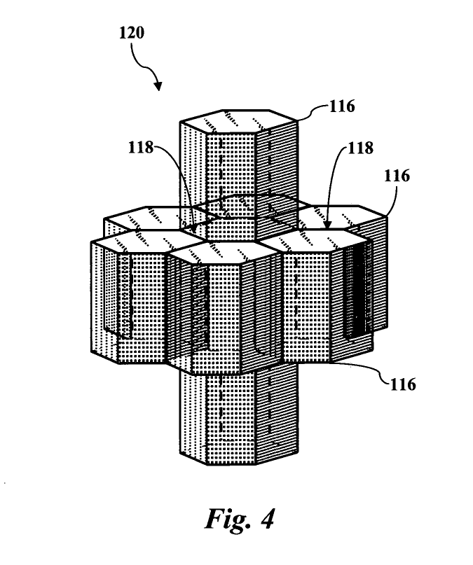

Referring to FIG. 4, a plurality of cells 116 may linked together forming a cluster of cells 120. Each cell 116 may be linked to one or more other cells 116 by aligning geometric surfaces 118. Any surface 118 of the cells 116 may be configured to link to a surface of another cell 116. In operation, the user may navigate the three-dimensional geographic space defined by the cluster 120.

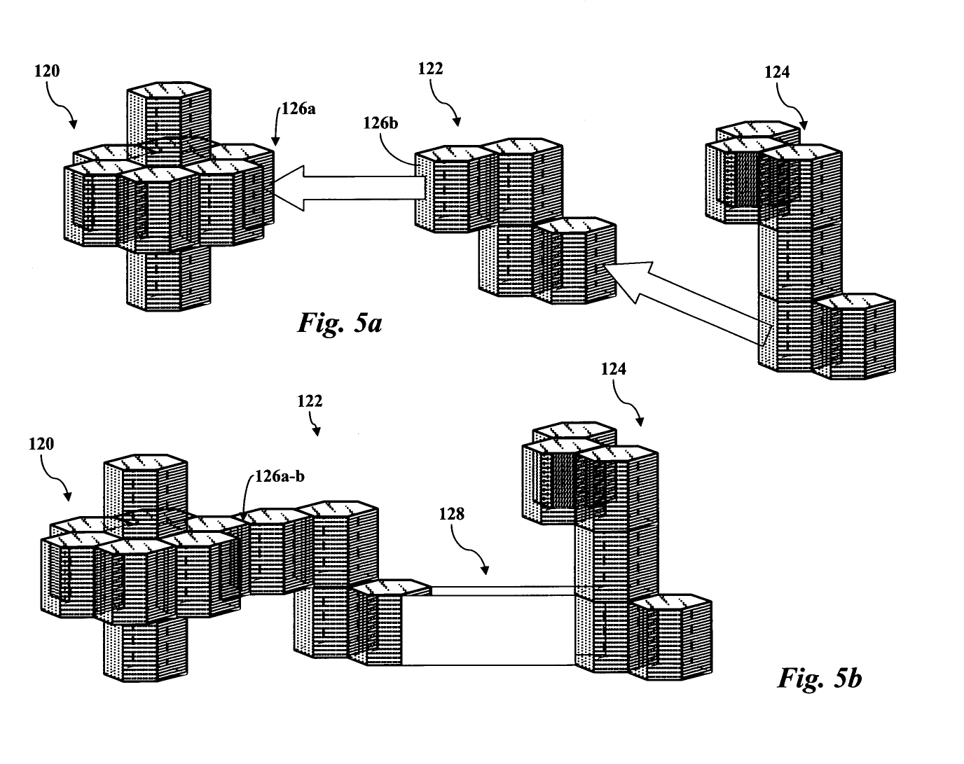

As illustrated in FIGS. 5a and 5b, the cluster 120 may also link to one or more other clusters 122, 124. Each of the clusters 120 and 122 includes a surface 126a and 126b, respectively, configured to bond to another cluster. Any surface of a cell may be configured to bond to another cluster and the number of bonding surfaces in a cluster is configurable. The clusters may be different shapes and may link with other clusters in accordance with the clusters' respective properties. Cluster properties that may restrict or enable bonding may include time, direction, security and privilege. A docking algorithm manages the bonding process and provides a security function which protects against the bonding of an unknown, dangerous or incompatible cluster. A cluster 124 may also link 128 to another cluster 122 without surface bonding that joins the geometric space.

The user may be presented with various views to assist in user navigation through clusters of cells. For example, a cluster view (see FIG. 4) would provide the user with a view of the cluster and related linked cells. The exterior of each cell may include a graphical representation of the cell's type or contents or alternatively, the exterior surfaces may provide a window into the contents of the cell. Each cell may be highlighted to indicate whether the cell has been visited or is a favorite. A world view provides an overview of all of the content in the geometric space. The user is provided with interface controls to rotate the geometric space and zoom in and out to see a visual representation of certain clusters and cells.

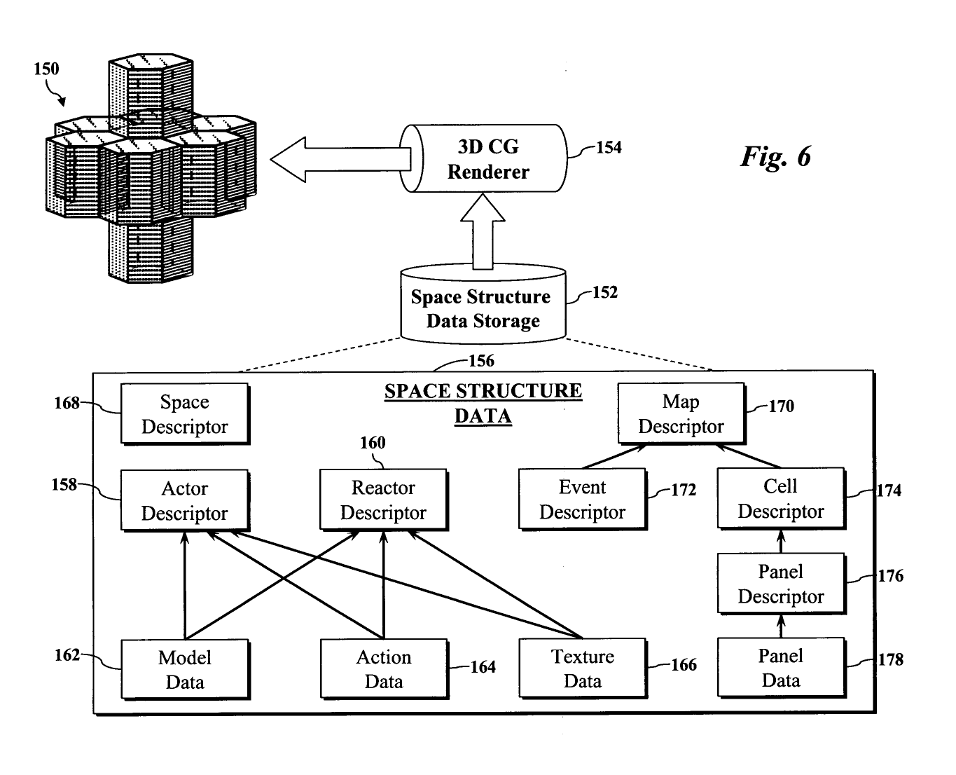

Referring to FIG. 6, an embodiment of space structure data is illustrated. A cluster 150 is graphically represented by a 3D GC renderer 154, in accordance with space structure data 156 stored in space structure data storage 152. The space structure data 156 includes data elements describing actors 158 and reactors 160, each having associated model data 162, action data 164 and texture data 166. The space descriptor 168 encapsulates data defining the space. A map descriptor 170 describes the map properties and has associated events 172 and cells 174. For each cell, further data is stored describing the panels 176 and data 178 for each panel is also stored. It will be appreciated that the illustrated data structure is exemplary and that other data structures may be used.

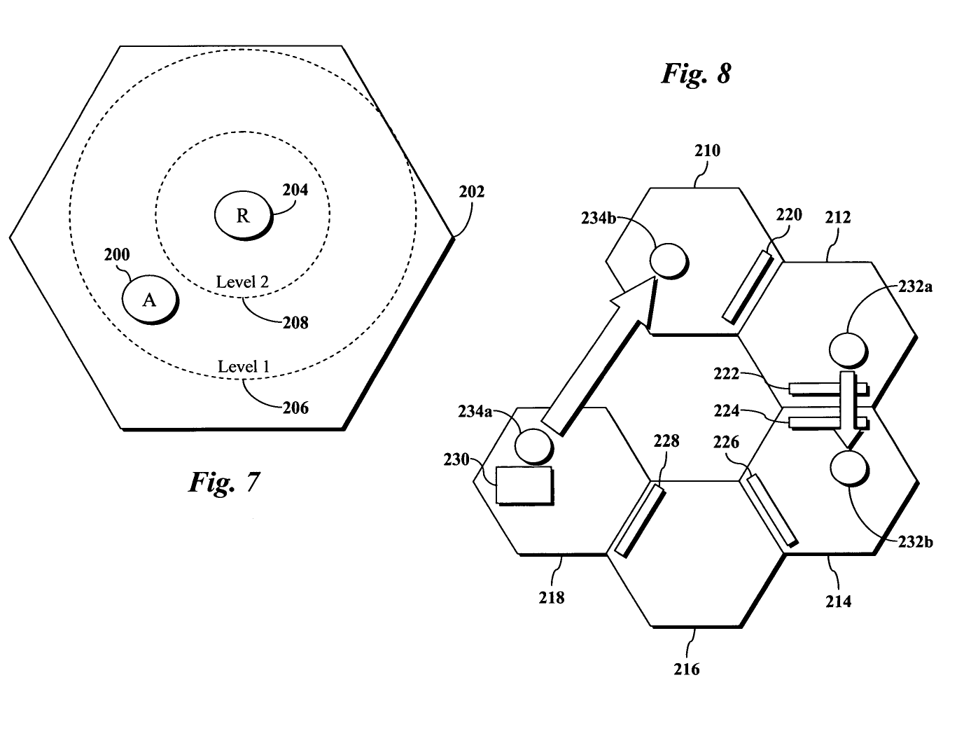

In operation, the 3DGUI provides the user with walkthrough interactivity. Referring to FIG. 7, the user controls an actor 200 within a cell 202. The actor 200 may be represented to the user as a three-dimensional character or avatar, or the user may select a first person or camera view of the cell 202. The actor 200 can walk through the cell 202 and explore and interact with the cell's contents. In various applications the user may perform a variety of actions with the actor including walk, run, jump, manipulate, fight, defend, smile, conversation and hug. The interface may display the cell from different points of view such as a camera view, subjective view and distance view, as the user desires.

In one embodiment, the interaction inside the cell 202 is facilitated by the spatial relations between the actor 200 and one or more reactors, such as reactor 204. A reactor is an interactive object or character in a cell which may be configured to react to the actor 200, such as in response to the distance between the reactor 204 and the actor 200. A reactor may be any object such as an animal, a door or a web link, and may be graphically represented. For example, three levels of interaction may be defined depending on the distance between the actor 200 to the reactor 204. A Level 1 response occurs when the actor 200 is in the vicinity 206 of the reactor 204. A Level 2 response occurs when the actor 200 is close 208 to the reactor 204. A Level 3 response occurs when the actor 200 makes contact with, or interacts with, the reactor 204.

Each actor 200 includes one or more attributes, which may create different responses in the reactor 204. For example, if the reactor 204 is defined as a cat it may have different reactions to an actor having an attribute of a dog than an actor having an attribute of a mouse. If the actor 200 has the attributes of a dog, the reactor 204 may freeze and watch the actor 200 when the actor 200 is within the Level 1 vicinity 206. The reactor 204 may hiss at the actor 200 if the actor 200 is within a Level 2 vicinity 208, and may try to run away if the actor 200 makes a Level 3 contact with the reactor 204. If the actor 200 is a mouse, the reactor 204 may respond by chasing the actor 200 when the actor 200 is within the Level 1 vicinity 206.

A reactor may also be defined as a transport reactor that enables a user to explore inside the geometric space. FIG. 8 illustrates an embodiment of transport reactor objects. An actor may walk through a cluster of cells 210, 212, 214, 216 and 218 using transport reactors 220, 222, 224 and 226 and 228 that transport the actor to an adjacent cell. For example, transport reactor 220 provides transport from cell 210 to cell 212. The movement between cells is carried out by the actor's level 3 contact to a transport reactor. As illustrated, an actor 232a making level three contact with the transporter 222 is transported to cell 224. The actor 232b may now interact with the interior of cell 224. A transport object may also transport an actor to a remote cell. An actor 234a making level three contact with a transport object 230 in cell 218 is transported to cell 210 as illustrated by actor 234b.

The 3DGUI framework of the present invention simplifies the expansion and representation of three-dimensional space and may be used as an interface for a variety of applications and services such as a community service, dating/match making, online gaming, content browsing, menu-GUI navigation, security service, self-history and journalist/blogger applications.

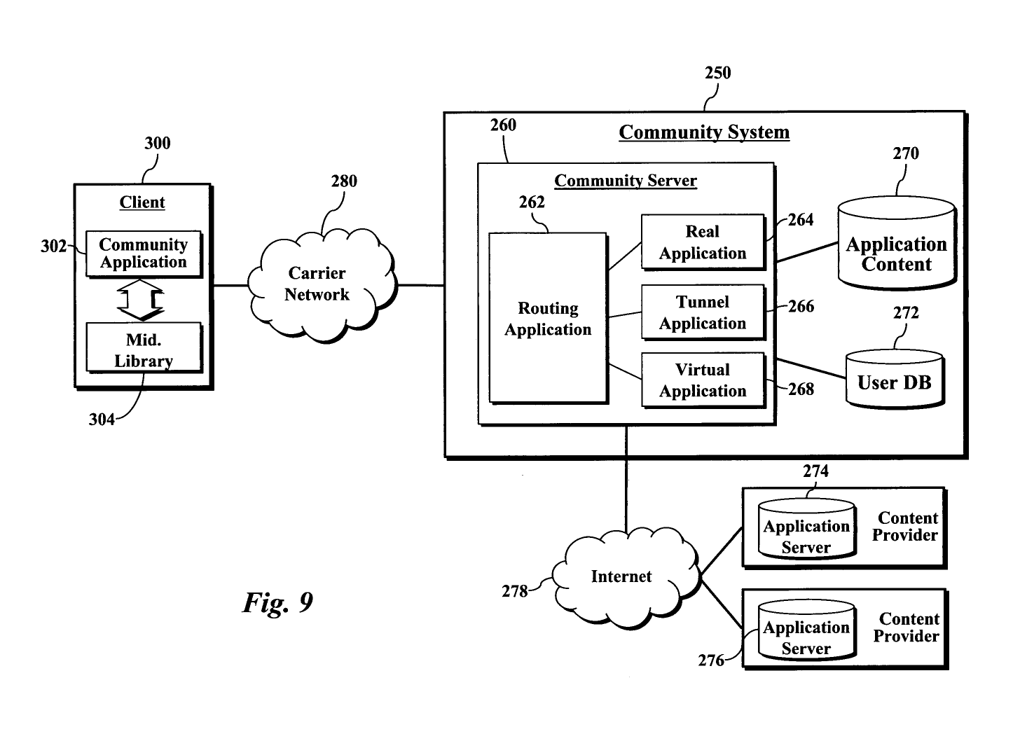

An embodiment of a community services implementation will now be described with reference to FIGS. 9-12. Online communities connect people through social networking services such as dating services, blogs, instant messaging, mail and online events. Some online communities also offer virtual communities allowing a user to play the part of a character in a virtual world, play games against other people on the network and participate in other virtual services.

Referring to FIG. 9, a community system 250 provides community services to subscribers of the carrier network 280, such as client device 300. The community system 250 includes a community server 260, an application content server 270 and a user database 272. The community server 260 is a 3DGUI content server that includes a routing application 262, a real application 264, a tunnel application 266 and a virtual application 268. The real application 264 provides real-world services to the client 300 such as a dating service, mapping service and news delivery. The virtual application 268 provides a virtual community to the client 300. Virtual services may include games and 3D virtual environments that the user may explore. The tunnel application 266 facilitates the client's movement between the real and virtual worlds. The community server 260 is interfaced with the Internet 278 providing access to third party content from content providers 274 and 276.

The client device 300 includes a community application 302 that interfaces with the middleware libraries 304 including the 3DGUI platform and community-based functions. The client device 300 is adapted to retrieve community data and content from the community server 260 and provide the user with community services through the 3DGUI.

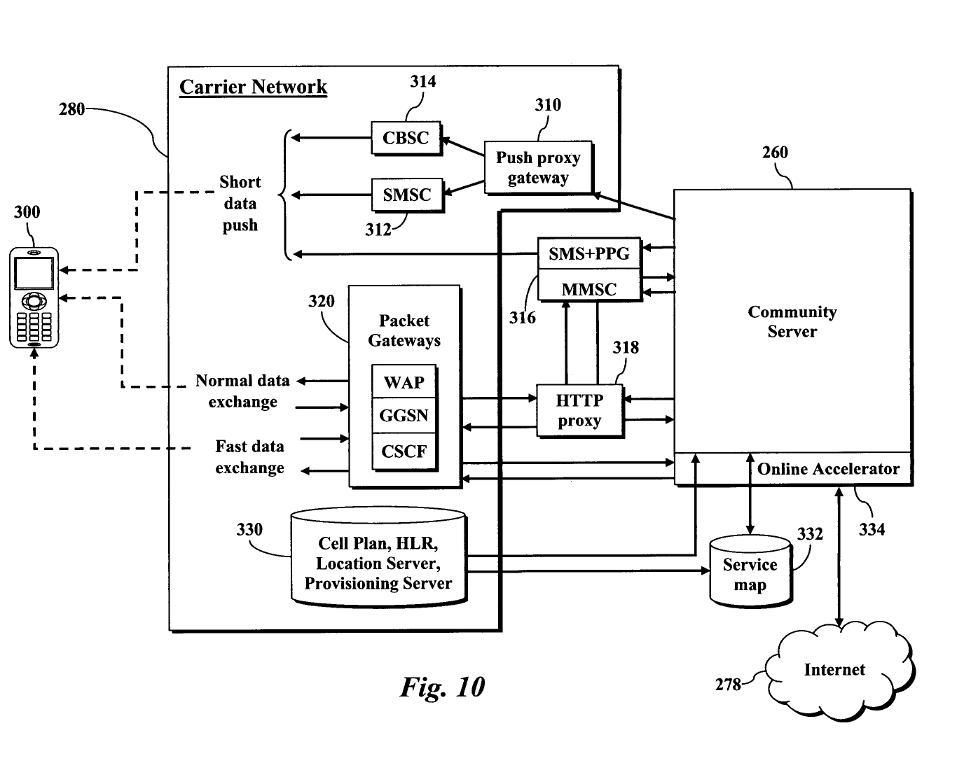

An embodiment of a data interface between the client device 300, the carrier network 280 and the community server 260 is illustrated in FIG. 10. In operation, the community server 260 pushes certain content to the client device 300 through space-time pushing, psychological profile pushing and cell plan synchronized pushing. To facilitate pushing, the community server 260 is interfaced with a push proxy gateway 310 which routes incoming data to a Short Message Service Center (SMSC) 312, for text messaging, and a Cell Broadcast Service Center (CBSC) 314, for broadcast messages such as advertisements including graphics, text, sound and link data. The interface may be facilitated over the Session Initiation Protocol (SIP) or Push Access Protocol (PAP). The community server 260 is also interfaced with a multimedia messaging service center (MMSC) 316 via the MM7 protocol for delivery of multimedia content to the client device 300. The MMSC 316 includes a SMS/Push Proxy Gateway (PPG).

The community server 260 is also connected to an HTTP proxy 318, which facilitates data exchange with the client device 300 through packet gateways 320 using packet based protocols such as HTTP, RTP and SIP. The packet gateways 320 include a Gateway GPRS Support Node (GGSN), a Call State Control Function (CSCF), and a Wireless Access Protocol (WAP) gateway.

Certain community services use information received from the carrier network 280, such as the location-based information services which use client device 300 location information and a carrier's cell plan information. The community server 260 is interfaced with carrier network databases 330 including a home location register (HLR) via a MAP interface, a location server via a multilink PPP (MLP) interface, and a provisioning server via a Lightweight Directory Access Protocol (LDAP) interface. A service map database 332 maintains information relating to the carrier network's cell plan for use with real applications. An online accelerator 334 improves data exchange between the community server 260 and packet gateways 320 and the Internet 278.

Referring back to FIG. 9, in operation a user provides input to the client device 300 requesting access to a community application. The community application 302 transmits personal data and location data to the community server 260 through the carrier network 280. The routing application 262 transmits the user's request to the appropriate application—real application 264, tunnel application 266 or virtual application 268—which processes the request. Next, service profiling is performed with access to the user's community database records 272 and the requested content server such as application server 270, or content servers 274 or 276 connected through the Internet 278.

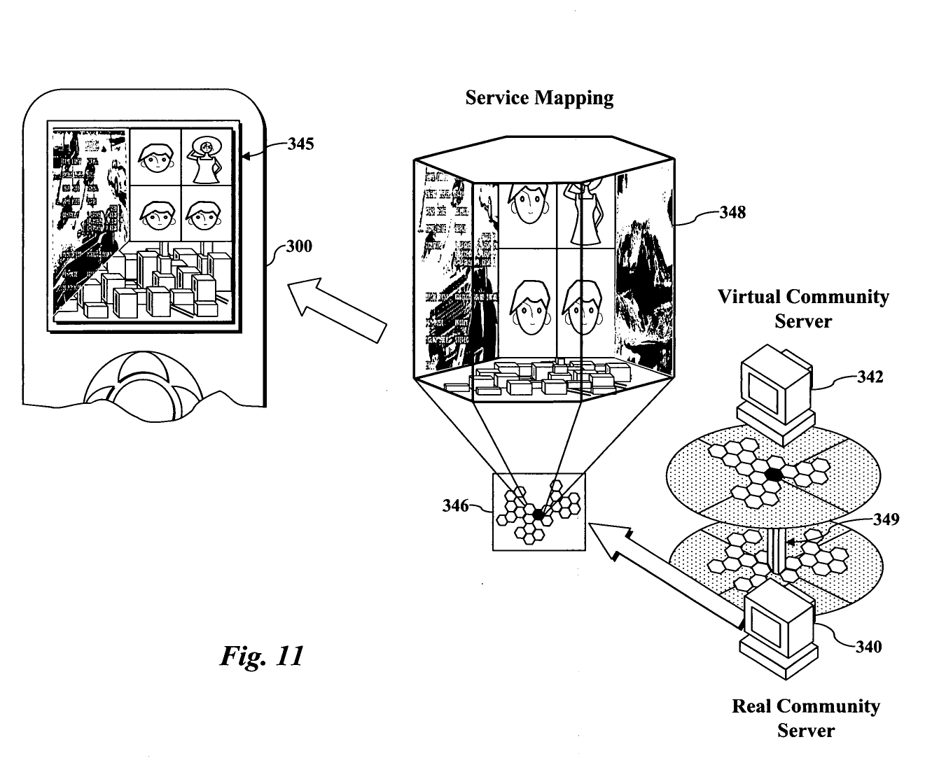

As illustrated in FIG. 11, the community server, via the real community server 340 or virtual community server 342, responds to the client device 300 with a service-map and link-data 346. The client community application 302 (FIG. 9) next provides the user with an indication that the service was accepted. The community data stored in the community server may be formatted as HTML or WML or other standard format. The retrieved community data formatted as HTML or WML is interpreted by a community parser library and provided to a GUI library in the middleware library 304 (FIG. 9) for construction of the 3D display cell 348. The 3D-rendering of the parsed community data is processed by the GUI library and presented on the display 345. If the parser of a conventional web browser is used, then the community data may be drawn as a web page in the usual 2D-rendering manner. To process the community data, the middleware library 304 includes community APIs providing space-time driven content service and a profile-driven content service, and 3D graphics features facilitating walkthrough community operation and actor and reactor control and operation.

The services provided through the community services system include a space-time based content provisioning mechanism, a content plan working with cell plan of a radio network, and a matching mechanism between user and content using psychological profiling. As shown in FIG. 11, community content and services are classified as either real 340 or virtual 342. The cell-type community provides the various interactive services and supports the navigation and the story making. The real community provides real services such as a map navigation service, dating service and news service. The virtual community provides virtual services such as gaming communities, virtual shopping community and virtual adventure community. Both communities are connected via the tunnel 349. Various community spaces are browsed by walkthrough operation, and various interactive events may occur inside the space.

The real community is driven by the real space-time such as local time, GPS position, cell position or service area of carrier. The community content available in the real community is linked to the real space-time and is provided to the user within the real community in accordance with the real space-time. Real community services may include information supplements such as local news, sports, music and advertising. Information retrieval may be tailored such as to local business, personal, lodging and shopping.

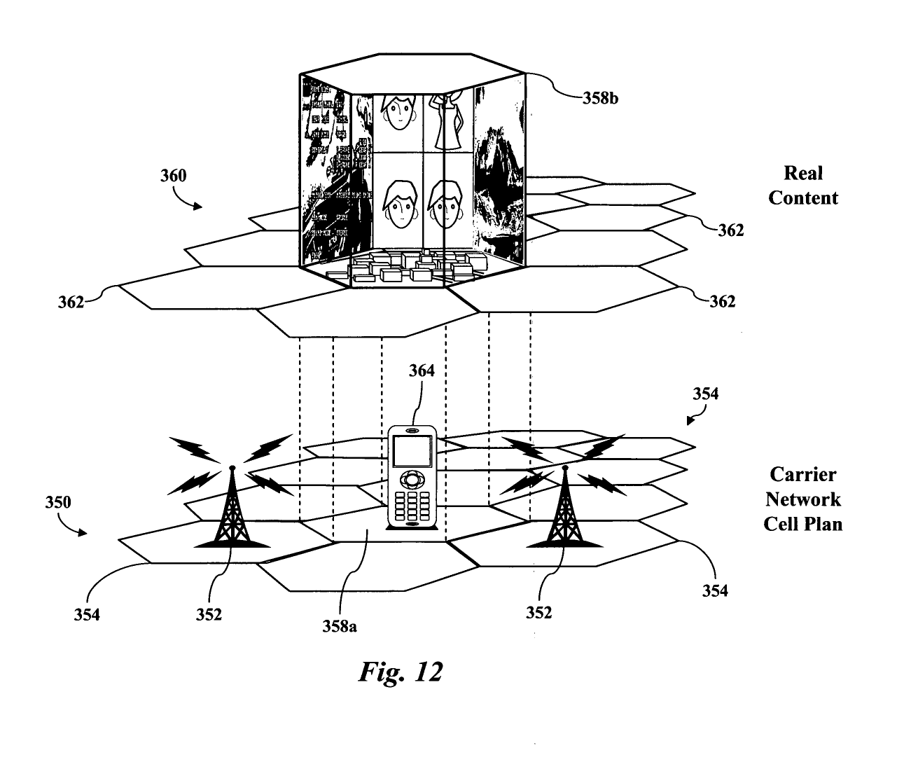

An embodiment of a real community system is illustrated in FIG. 12. A carrier network 350 includes a plurality of base stations 352, each having an associated geographic coverage area or cell 354. Real content 360 includes a geometric space that corresponds to the cell plan of the carrier network 350. As a mobile device 364 moves throughout the coverage area, real content 360 is delivered that provides the user with local, time and profile based information. As illustrated, the mobile device 364 is within a radio network cell 358a that has a corresponding content cell 358b. Examples of the space-time content delivered to mobile device 364 through cell 358 may include a local map, the identity of friends who are in the vicinity, local news or local services such as restaurants.

The virtual zone is the aggregate of virtual communities. Each virtual community is driven by the virtual space-time which is set by each application of the virtual community. The virtual zone services may include lobby, playroom, business room, shopping room and other services. The virtual space-time domain may include virtual space-time, and room time control such as rewind, fast-forward and stop.

The user passes through the tunnel zone when entering and exiting the virtual zone or the real zone. Tunnel zone services include a gatekeeper function to check the user's access privileges and digital rights management services to check content leaving the system.

Many community services use profiling to enhance the user experience and facilitate better matching between users, between users and the communities, and between users and content. Social psychology profiling parameters, which match a user to social situations, may include a grittiness parameter measuring whether the user can make a decision by himself and reach a goal responsibly, a estimate of the situation parameter measuring whether a user can objectively recognize its environment, a manipulation parameter measuring whether a user can manipulate user's feelings in a calm manner, and a sympathy parameter of whether the user can get wind of the feelings of those around and share with own idea. Love psychology profiling parameters, which match a user to another person, may include a similarity parameter measuring a degree of match between hobbies and interests, an equivalency parameter measure a match of sense of worth, a physical distance parameter measuring how far apart each user is, a contact interval parameter measuring how frequently both have met, and a balance parameter measuring how deeply in love with each other they are.

Some content provided to the user is the profile-dependent content which is offered in accordance with the user's community profile. The community profile determines the closeness between the content and the user. The degree of closeness dynamically relocates the contents, which brings about a change of relation between the user and the contents. Content may include news stories of interest, targeted advertising and invitations to events of interest. In one embodiment, the community services includes an event-guidance service interface that generates frequent events related to service and content to lead passive users to content based on user profile, location and time.

Another service is a self-history feature that includes private information and history recorded in the geometric space, allowing for walkthrough-browsing of the record in geometric space. Through the online community, any user may become a journalist and post a local news story to the news community or a travel record to the travel community. The community server maintains a history through which a user may create, record, and watch the user's personal history, family history and local community by using a camera and voice recorder of the mobile phone. The user can walk through the community space of his own personal history and also watch the other people's histories. In another embodiment, the three-dimensional graphical user interface facilitates a gaming interface that is free from the limitations of a hierarchical interface, enabling a more intuitive cross-cultural human interface.

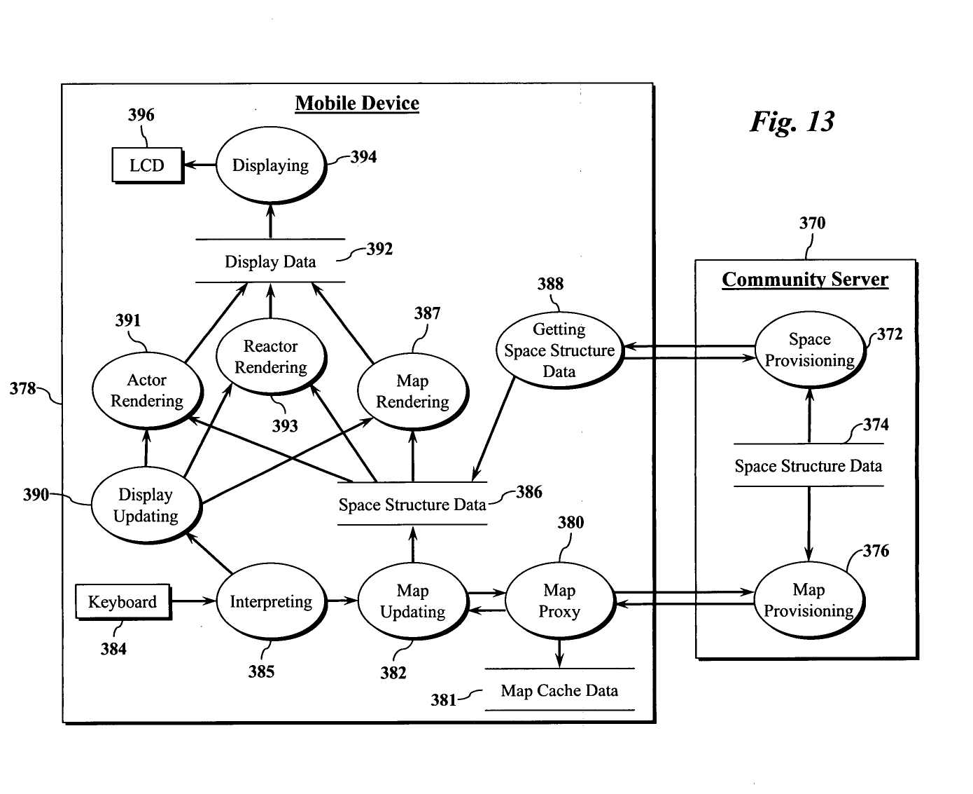

In operation, 3DGUI and community content is provided to the mobile device from the community server. An interaction between the mobile device and the community server is illustrated in FIG. 13. A community server 370 includes a space provisioning server 372 and a map provisioning server 376, both of which provide relevant space structure data 374 to the mobile device 378. Map data is transmitted to the map proxy 380 and stored in map cache data 381 in accordance with the memory capacity of the mobile device 378. Space structure data is retrieve via the getting space structure data function 388 and stored on the mobile device as space structure data 386.

The mobile device 378 includes a keyboard 384 for receiving user input which is interpreted by the interpreting function 385. The user input from the keyboard 384 may relate to user navigation through the 3DGUI requiring an update of the display through display updating function 390 and/or an updating of map data via the map updating function 382. The space structure data 386 provides data for rendering the actor 391, reactors 393 and map 387. After rendering, the data is combined as display data 392 which is displayed on the LCS 396 via the displaying function 394.

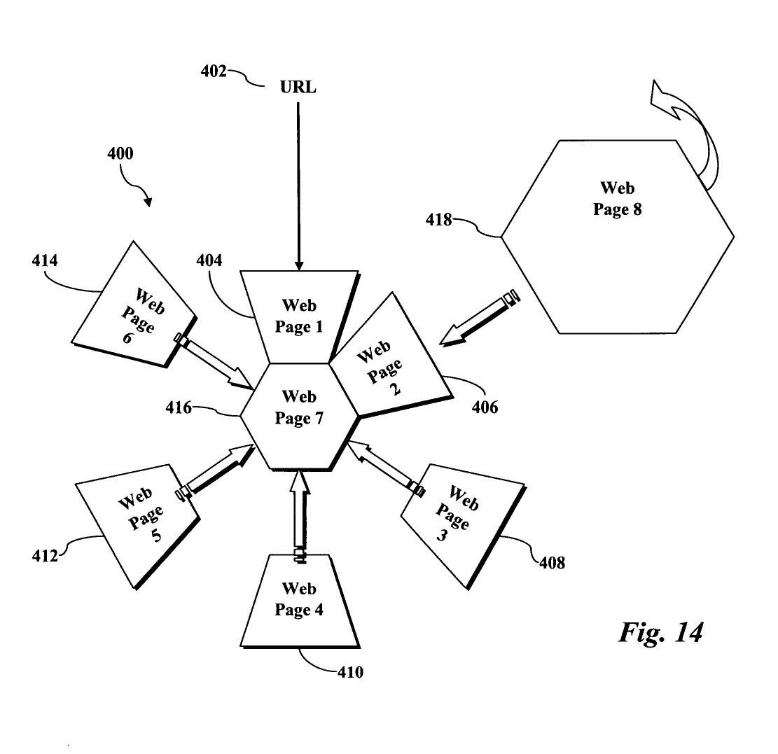

The 3DGUI may provide an interface for a variety of applications including games, web browsers and operating systems. An embodiment of a web browsing application will be described with reference to FIG. 14. The user first initiates a browser application on the client device. The browser retrieves the content for the first cell 400 from the content distribution system and provides the content to a space builder application which constructs the 3D cell 400 and provides an initial view for the display. The user interacts with the display using the client device user input to scan the contents of the 3D cell and select links for further browsing. The browser provides geometric view control enabling the user to change the look of the interface, view angle, dimensions between 2D and 3D, magnification (zoom in or out), between HTML page and 3D view, from a hierarchical menu to and from a 3D space menu. The browser application also provides history and profiling functions. The command operations and the acquired data can be recorded as geometric space, and the geometric record can be played back through walkthrough operation. The 3D geometric space interface enables the collection of data of the user's preferences and behaviors by tracing the history of the user's walkthrough in the specific geometric space.

When browsing 3D content, the browser builds the cell defined by the received content. The 3D content may take any form supported by the content distribution system. In one embodiment, 3D web content may be provided in an HTML document with tags indicating the placement of content in the browser cell. For example, 3D web content may include links to web pages for display on each of the interior surfaces or include a predefined tags specifying how and where to display the HTML document on multiple surfaces.

When browsing 2D content, such as conventional web pages, the browser builds the cell with a plurality of web pages or other content in accordance with user preferences and content profiling. In operation, a user enters a URL 402 which is forwarded to the content distribution system. The content distribution system retrieves the associated web page 404 which forms one interior surface of the cell 400. In one embodiment, the remaining interior surfaces 406, 408, 410, 412, 414, 416 and 418 include the preceding seven web pages visited by the user. In a second embodiment, each interior surface 406-418 may be a dedicated display for an associated application, such as a map, contact database, email and other non-web application. In a third embodiment, the interior surfaces 406-418 may be filled through content profiling to provide the user with suggested content such as advertisements or suggested web pages.

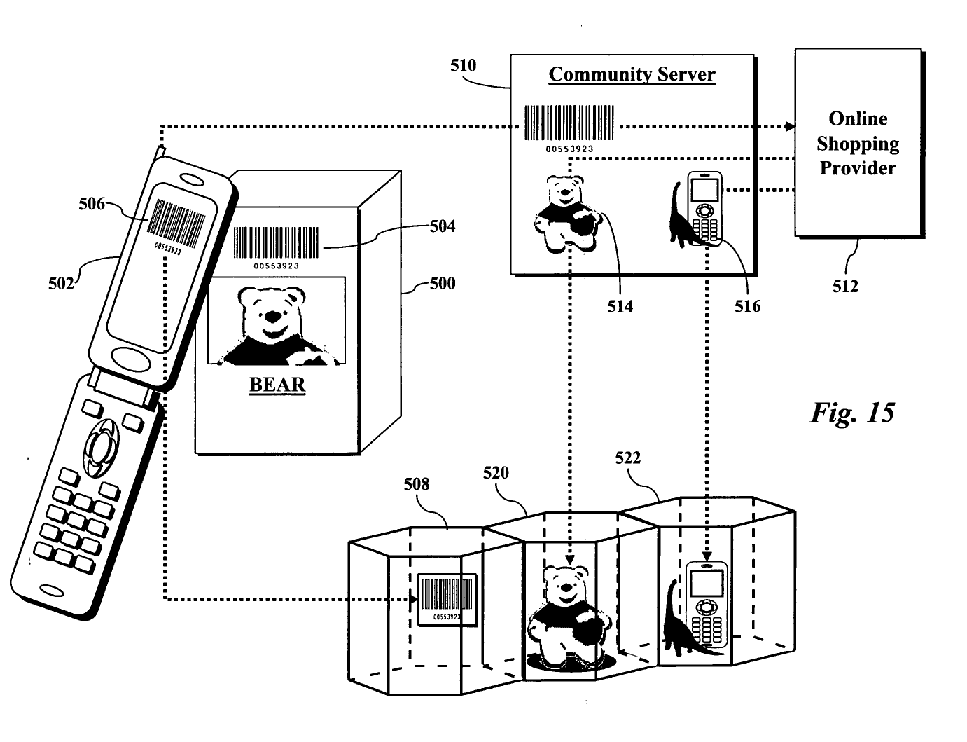

Referring to FIG. 15, an embodiment of an online shopping application will now be described. A person shopping at a retail store may desire more information on a product 500 that is being considered for purchase, such as reviews and testimonials from other people who bought the product and the price that other stores are charging. The shopper initiates a shopping application on a camera phone 502, which displays a portion of a cell 508 defining a shopping interface. With the camera phone 502, the shopper takes a picture of a bar code 504 on the product 500. An image of the bar code 504 is then added to the current cell 508 and displayed 506 on the camera phone 502.

The shopping application transmits the barcode image to the community server 510, which interprets the bar code image and transmits the resulting barcode data and shopper personal information to an online shopping site 512. The online shopping site 512 returns product information 514 to the community server 510, which returns product cell 520 data to the camera phone 502. The shopper may then enter the cell 520 to view the product and product information. In one embodiment, the shopper is provided with the option of purchasing the product instantly through the online shopping provider. In addition to the product information, the online shopping provider 512 may transmit wish list information 516 to the community server 510, which returns wish list cell 522 data to the camera phone 502. The wish list includes products previously identified by the shopper as being desired for future purchase.

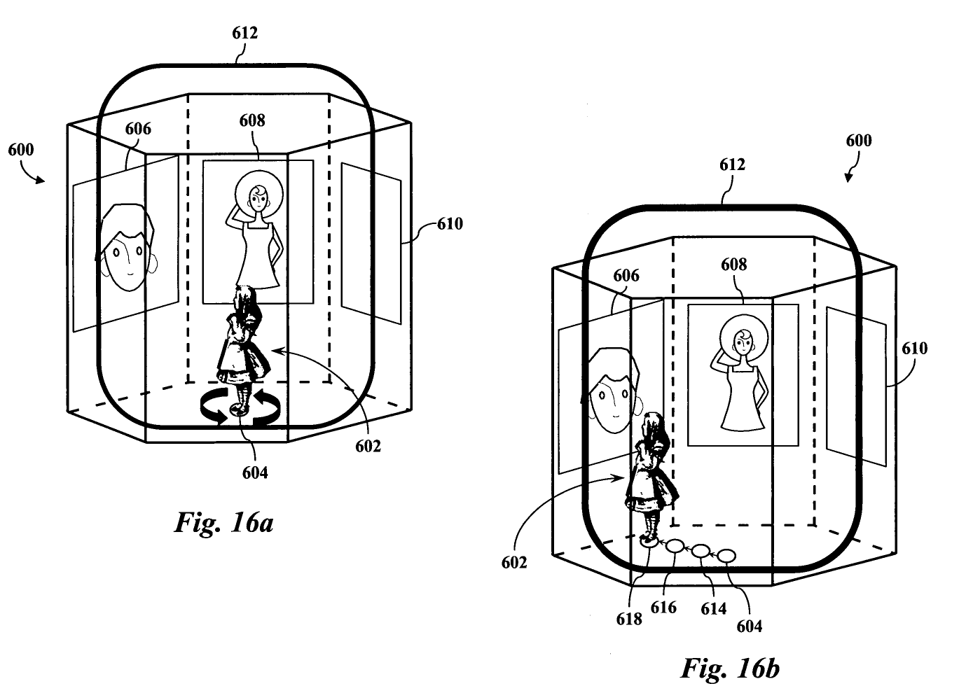

Referring to FIGS. 16a and 16b, an embodiment of a chat application is illustrated. A user 602 enters a chat room cell 600 and looks around the cell using the input functions of the mobile device. A portion of the cell 600 is visible to the user through the display 612. The user 602 may check the status of a friend by looking at each person's presence texture panel (e.g., 606, 608 and 610) using the directional keys of the mobile device. As illustrated, the user 606 is available for a chat, the user 608 has the chat function turned off and a third panel 610 provides an indication that that person is busy. The user 604 may select an online buddy by looking at the texture panel with the directional keys of the mobile device. In one embodiment, taking one step closer to the texture panel (to position 614) will start a text chat. Taking two steps closer to the texture panel (to position 616) will start a voice chat, and taking taking three steps closer (to position 618) will start a video chat.

Having thus described various embodiments of the present invention, it should be apparent to those skilled in the art that certain advantages of the within described system have been achieved. It should also be appreciated that various modifications, adaptations, and alternative embodiments thereof may be made within the scope and spirit of the present invention.

What is claimed is:

1. A three-dimensional graphical user interface comprising:
a graphical display;
a memory storing a virtual three-dimensional geometric space including a plurality of three-dimensional cells, each cell having an interior and an exterior and having a link to at least one other cell; and
a program memory including instructions for causing the graphical user interface to:
display an interior view of a first cell, the view controllable through a walkthrough interface; and
display an exterior view of the geometric space, the view controllable through a user interface.

2. The graphical user interface of claim 1 wherein the interior of the first cell includes a transport reactor object, wherein user interaction with the transport reactor object changes the display view to the interior of a second cell.

3. The graphical user interface of claim 1 wherein each cell is a hexagonal prism.

4. The graphical user interface of claim 1 wherein at least one cell includes content texture mapped on an interior surface.

5. The graphical user interface of claim 1 wherein the walkthrough interface includes user control of a graphical character displayed within the first cell.

6. The graphical user interface of claim 1 wherein each cell is linked to at least one other cell through an adjoining exterior surface.

7. The graphical user interface of claim 1 wherein the three-dimensional geometric space corresponds to a physical space, and wherein at least one cell includes content associated with a corresponding portion of the physical space.

8. A method for viewing content on a mobile device comprising:
transmitting a request for three-dimensional content to a content server;
receiving cell data associated with the requested content;
building a virtual three-dimensional cell using the received cell data;
displaying a view of the cell's interior; and
providing an interactive walkthrough interface, the interface changing the displayed view of the cell's interior in response to user input.

9. The method of claim 8 wherein the three-dimensional content includes a two-dimensional web page, and wherein the step of building includes texture mapping the web page on an interior surface of the cell.

10. The method of claim 8 wherein the cell interior includes at least one reactor object that responds based on a distance between the user's position in the cell's interior and the position of the reactor object.

11. The method of claim 10 wherein the at least one reactor object includes a hypertext link.

12. The method of claim 8 wherein the request includes user information and location information, and wherein the cell data includes content relating to the user and location information.

13. The method of claim 8 wherein the cell is an n-sided prism, where n is greater 4.

14. In a carrier network providing wireless services to a mobile device, a content delivery system comprising:
a content database storing data representing a virtual three-dimensional geometric space including a plurality of linked three-dimensional cells; and
a content server coupled to the content database, the content server including a program memory storing program instructions for causing the content server to:
receive a request for three-dimensional content from the mobile device;
retrieve data associated with the requested content;
construct a cell with the retrieved content; and
transmit the constructed cell to the mobile device.

15. The content delivery system of claim 14 wherein the transmitted cell includes dynamic content, and wherein the content server periodically pushes new dynamic content to the mobile device for display in the transmitted cell.

16. The content delivery system of claim 14 further comprising a user database storing user profile data, and wherein the constructed cell includes data selected in accordance with the user profile data associated with the mobile device.

17. The content delivery system of claim 14 wherein the content server tracks the mobile device's movement through the virtual three-dimensional geometric space.

18. The content delivery system of claim 12 wherein the constructed cell includes a two-dimensional web page.
